(19) United States
(12) Patent Application Publication
(10) Pub. No.: US 2011/0195276 A1
(43) Pub. Date: Aug. 11, 2011

(54) RESIST ADHENSION TO CARBON OVERCOATS FOR NANOIMPRINT LITHOGRAPHY

(75) Inventors: Wei Hu, San Mateo, CA (US); Nobuo Kurataka, Campbell, CA (US); Yuan Xu, Santa Clara, CA (US); Gennady Gauzner, San Jose, CA (US)

(73) Assignee: Seagate Technology LLC, Scotts Valley, CA (US)

(21) Appl. No.: 12/703,887

(22) Filed: Feb. 11, 2010

(51) Int. Cl. G11B 5/702; B05D 5/08; B05D 3/12

(52) U.S. Cl. 428/833.5; 427/127; 427/299

(57) ABSTRACT

In an imprint lithography process, a carbon overcoat (COC) layer has nitrogen introduced into an upper surface region thereof before application of an adhesion layer to the COC/substrate combination. This results in the formation of a thin layer of nitrogenated carbon at the surface of the COC layer that promotes covalent bonding with the functional groups of the adhesion layer and, thus, significantly improves resist adhesion upon imprint template removal. Thus, an embodiment of an imprint lithography method comprises introducing nitrogen into an upper surface region of the COC layer, forming an adhesion layer on the nitrogenated COC layer, forming resist on the adhesion layer, contacting the resist with an imprint template having patterned features formed therein such that the resist fills the patterned features of the imprint template, and separating the imprint template from the resist such that a negative image of the patterned features is formed in the resist. An embodiment of an imprint structure comprises a substrate, a COC layer formed on the substrate, the COC layer having a nitrogenated upper surface region formed therein, and adhesion layer formed on the COC layer, and resist formed on the adhesion layer.

### FIELD OF THE INVENTION

The present invention relates generally to imprint lithography and, in particular, to structures and methods for improving imprint resist adhesion to protective carbon overcoats (COC) utilized in patterned magnetic media by introducing nitrogen into the COC to promote covalent bonding between an adhesion layer and the COC.

### BACKGROUND OF THE INVENTION

Imprint lithography is a low cost alternative for patterning nanometer features in the surface of a substrate. Nanoimprint lithography has been aggressively pursued by the magnetic recording industry for patterned media development.

Imprint lithography involves the utilization of an imprint template to pattern a thin film layer, typically a thermoplastic polymeric layer (e.g., resist), that is formed on a substrate. The template includes a molding surface that includes a plurality of features that form a desired topographical pattern. The molding surface of the template is pressed into the thin film layer, utilizing either mechanical or electrostatic force, to form compressed regions that correspond to the patterned features of the template. Thus, when the imprint template is separated from the thin film layer, a negative (or complementary) image of the topographical pattern of the template is transferred to the thin film layer. The patterned thin film layer is then used as a mask to pattern the underlying substrate for further processing.

As is well known, thin film magnetic recording discs and disc drives are conventionally employed for storing large amounts of data in magnetizable form. In conventional hard disc drives, for example, data are stored in terms of bits along tracks that have been defined in a thin film magnetic layer. The data are stored on the tracks by patterning the thin film magnetic layer using, for example, ion bombardment.

In the formation of a conventional thin film magnetic layer for magnetic recording disc applications, a non-magnetic substrate, e.g., a glass substrate, is typically selected. A multilayer magnetic thin film stack is then formed on a surface of the substrate. The magnetic thin film stack can comprise any of a number of well know structures. For example, the magnetic stack may comprise several layers of cobalt-based materials, such as a cobalt-platinum alloy, cobalt-chromium alloy, cobalt-platinum-chromium alloy, cobalt-platinum oxide, cobalt-platinum-chromium oxide, cobalt-platinum-silicon and cobalt-platinum-chromium-silicon. The magnetic stack material may also include additive elements such as B, Ta, Mo, Cu, Nd, Nb, Sm, Ru and Re.

With reference to FIGS. 1A and 1B, in some applications, such as “step and flash” imprint lithography, an adhesion layer 102 is deposited on the upper surface of a substrate 100 to enhance the adhesion of the thin film resist layer 106 to the substrate 100 after separation of the imprint template 104 from the imprinted resist 106. The adhesion layer 102 usually comprises polymeric components having carboxylic functional groups capable of bonding to the substrate 100 by forming covalent bonds, and with an additional functional group capable of bonding with the imprint resist 106. For example, the adhesion layer 102 may comprise Valmat, which is commercially available from Molecular Imprints, Inc. located in Austin, Tex.

With reference to FIG. 2A, to prevent magnetic media from corroding, and also to protect the magnetic media from damage, such as from contact with a slider, as well as to prevent the magnetic head from contacting the media, it is desirable in some applications to form a protective carbon overcoat (COC) layer 108, e.g., diamond-like carbon (DLC), on the upper surface of the magnetic stack substrate 100, typically utilizing plasma chemical vapor deposition (CVD). The adhesion layer 102 (e.g., Valmat) is then formed on the COC layer 108 to enhance adhesion of the resist 106 to the substrate 100 upon separation of the imprint template 104 from the resist 106.

However, formation of the adhesion layer 102 directly on the COC layer 108 fails to provide sufficient resist adhesion. The low surface energy of the COC layer 108 makes it less reactive to form covalent bonds with the carboxylic functional groups of the adhesion layer 102, resulting in poor adhesion when the imprint template 104 is removed from the resist 106. This poor adhesion results in resist 106 peeling off of the substrate 100 upon separation of the imprint template 104 from the resist 106, as schematically illustrated in FIG. 2B.

In view of the above, there exists a need for improved imprint lithography techniques for maintaining adhesion between the resist and the underlying substrate upon imprint template removal when a protective COC layer is formed on the substrate. These techniques are useful in nanoimprint lithography in the fabrication of bit patterned media “BPM”).

### SUMMARY OF THE INVENTION

In accordance with the present invention, nitrogen is introduced into an upper surface region of a protective carbon overcoat (COC) layer formed on a substrate in a nanoimprint lithography process before application of an adhesion layer to the COC/substrate.

An embodiment of an imprint lithography method in accordance with the present invention comprises introducing nitrogen into an upper surface region of a carbon overcoat (COC) layer, forming an adhesion layer on the nitrogenated COC layer, forming resist on the adhesion layer, contacting the resist with an imprint template having patterned features formed therein such that the resist fills the patterned features of the imprint template, and separating the imprint template from the resist such that a negative image of the patterned features is formed in the resist.

An embodiment of an imprint structure in accordance with the present invention comprises a substrate, a carbon overcoat (COC) layer formed on the substrate, the COC layer having a nitrogenated upper surface region formed therein, an adhesion layer formed on the COC layer, and resist formed on the adhesion layer.

Additional features and advantages of the present invention will become readily apparent to those skilled in the art from the following detailed description of the invention, wherein embodiments are shown and described by way of illustration. As will be realized by those skilled in the art, the present invention is capable of other and different embodiments, and its several details are capable of modifications in various respects, all without departing from scope of the present invention. Accordingly, the drawings and description provided herein should be regarded as illustrative, not restrictive.

### BRIEF DESCRIPTION OF THE DRAWINGS

FIG. 1A is a schematic cross-sectional view illustrating a conventional imprint stack having an adhesion layer formed directly between a substrate and resist.

FIG. 1B is a schematic cross-sectional view illustrating resist adhesion in the FIG. 1A imprint stack.

FIG. 2A is schematic cross-sectional view illustrating a conventional imprint stack having a carbon overcoat (COC) layer formed on a substrate and an adhesion layer formed between the COC layer and resist.

FIG. 2B is a schematic cross-section illustrating poor resist adhesion in the FIG. 2A imprint stack.

FIGS. 3A-3F are schematic cross-sectional drawings illustrating a process sequence for perfoming imprint lithography in accordance with the concepts of the present invention.

FIG. 4 is schematic cross-sectional view with expanded highlight illustrating the state of the COC layer surface subsequent to N₂ treatment in accordance with the concepts of the present invention.

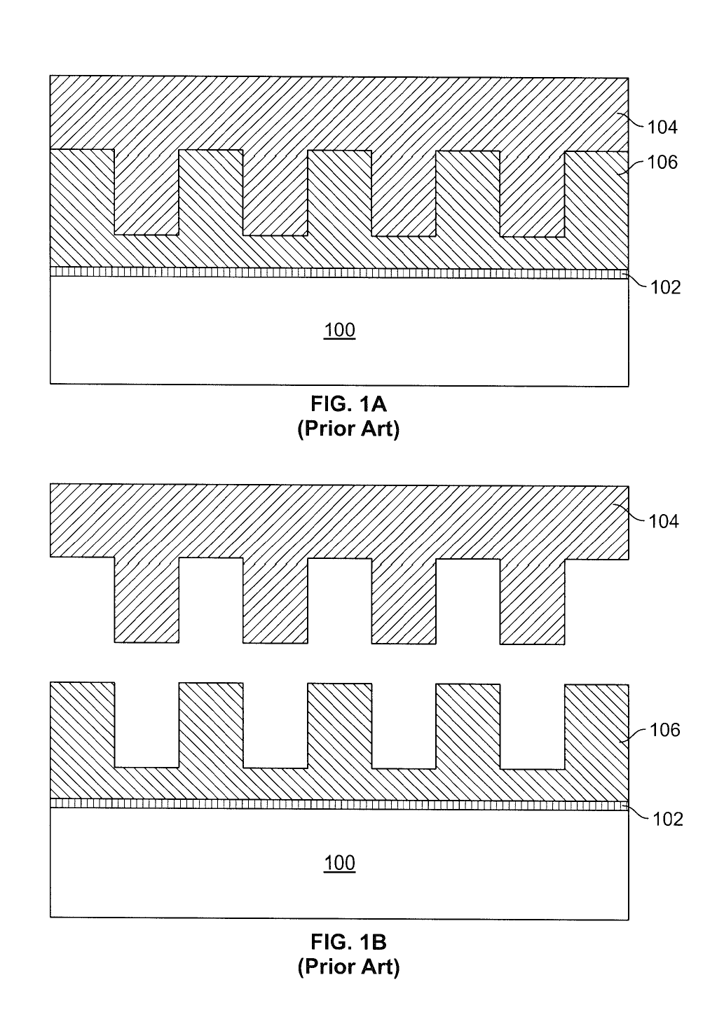

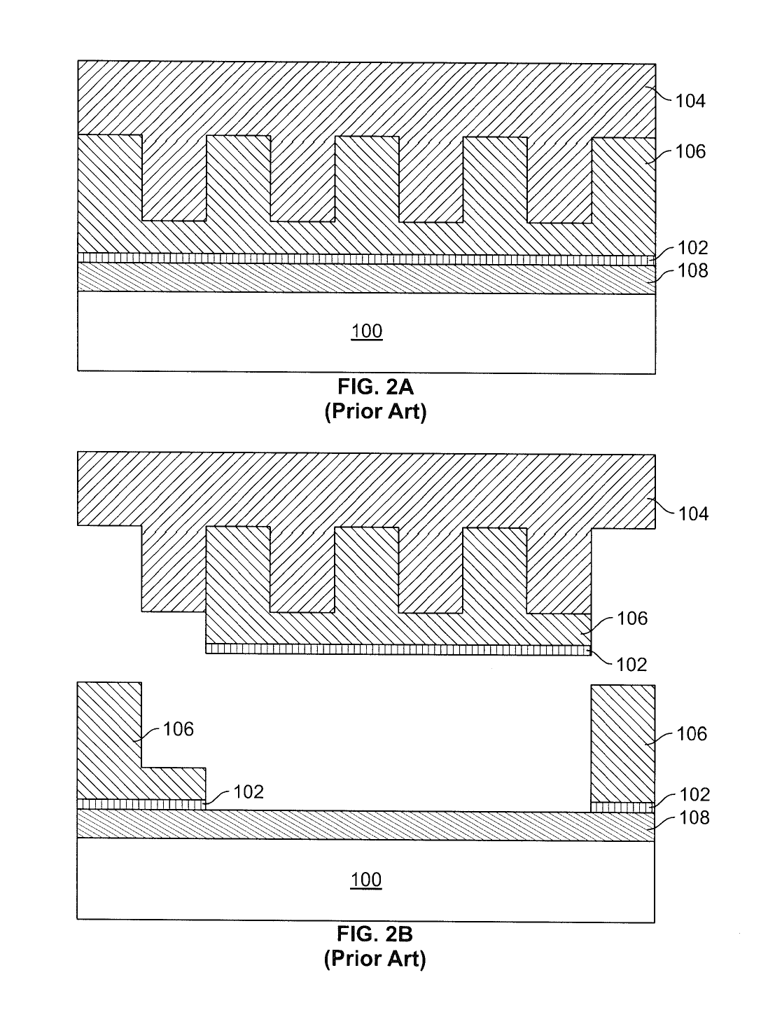

### DETAILED DESCRIPTION OF THE INVENTION

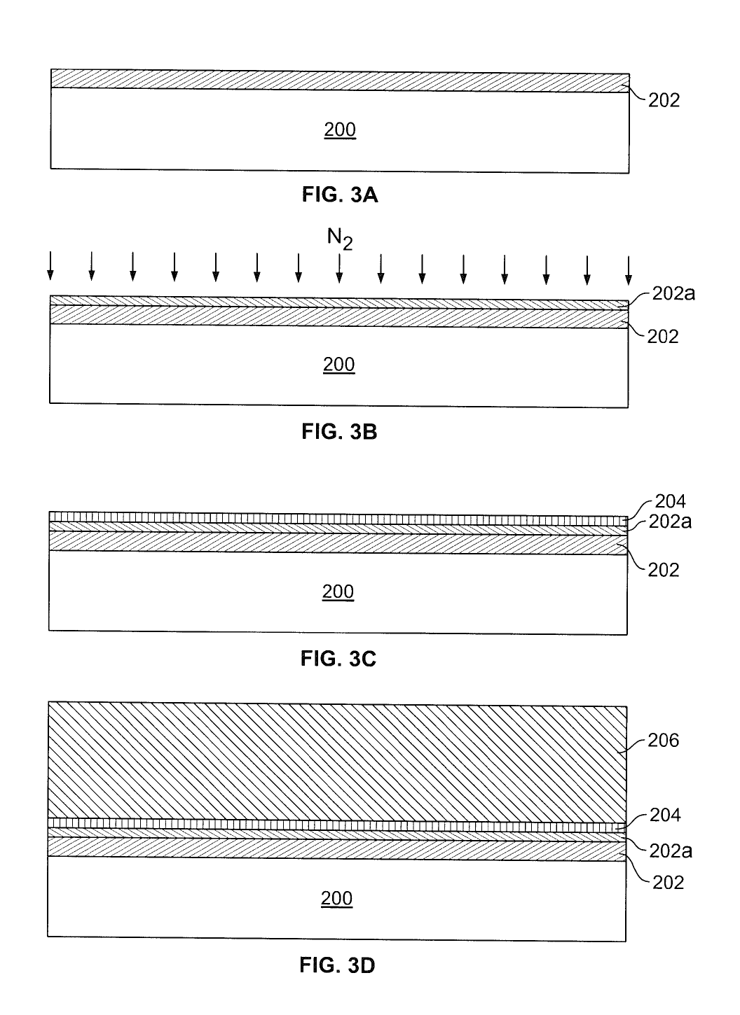

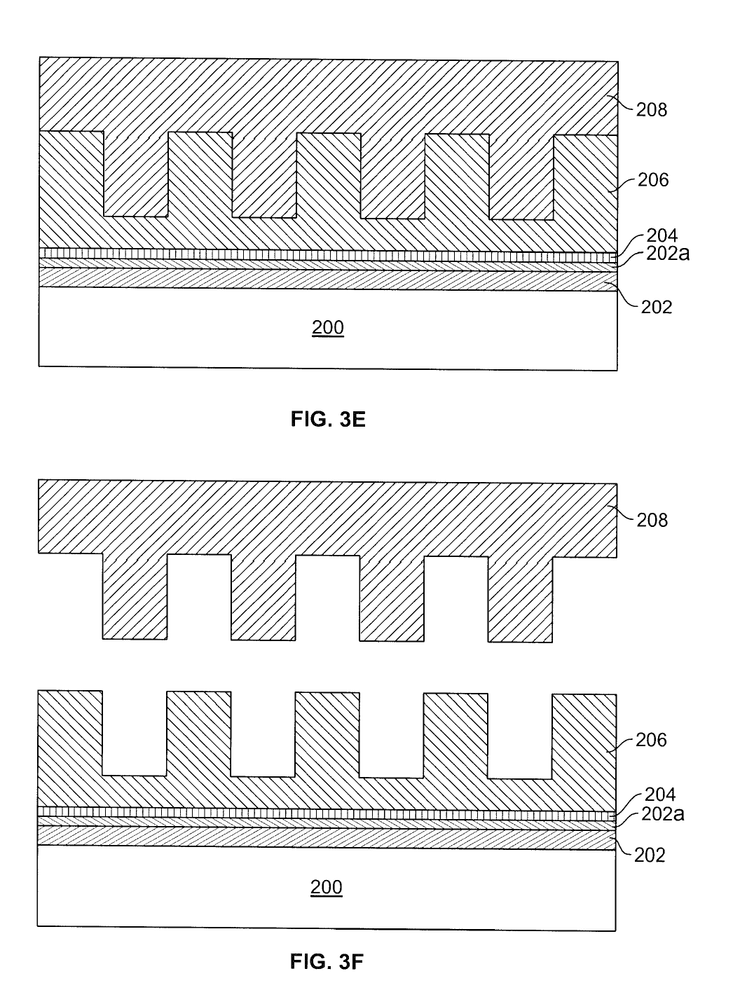

FIGS. 3A-3F illustrate an embodiment of a process sequence in which nitrogen is introduced into an upper surface region of a protective carbon overcoat (COC) layer formed on a substrate, such as a magnetic medium stack. The protective overcoat (COC) layer is exposed to nitrogen treatment before application of an adhesion layer to the COC/substrate combination. This results in the formation of a thin layer of nitrogenated carbon (C:N) at the surface of the COC layer 108 that promotes covalent bonding with the functional groups of the adhesion layer, resulting in significantly improved resist adhesion to the adhesion layer and substrate upon removal of an imprint template from resist formed on the adhesion layer.

FIG. 3A shows a carbon overcoat (COC) layer 202, e.g., as diamond-like carbon (DLC), formed on an upper surface of a substrate 200 in the conventional manner, e.g., by sputtering or chemical vapor deposition (CVD). Those skilled in the art will appreciate that the substrate 200 may be a conventional thin film magnetic stack for magnetic recording applications that comprises several layers of cobalt-based materials, such as, for example, cobalt-platinum alloy, cobalt-chromium alloy, cobalt-platinum-chromium alloy, cobalt-platinum-oxide, cobalt-platinum-chromium-oxide, cobalt-platinum-silicon and cobalt-platinum-chromium-silicon and that additive elements such as, for example, B, Ta, Mo, Cu, Nd, Sm, Ru and Re and combinations thereof can also be present in the substrate material. Those skilled in the art will also appreciate that the COC layer 202 usually contains high sp³ bonding that exhibits extreme micro-hardness, smooth morphology, good optical transparency, high resistivity and chemical inertness.

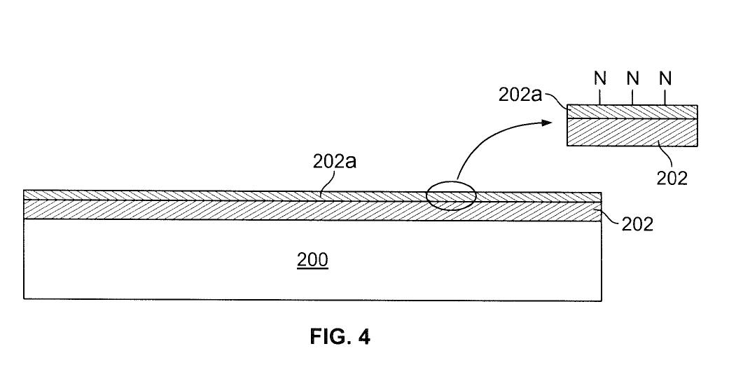

As shown in the FIG. 3B embodiment, the COC layer 202 is then exposed to N₂ plasma treatment to form a thin layer 202a of nitrogenated carbon at the surface of the COC layer 202. For example, a magnetic stack substrate 200 with 28 Å COC layer formed thereon may be processed with N₂ plasma in an Anelva DTM/BTM vacuum chamber for 1.5 seconds at the following conditions: RF Power=110 W, Bias=−50V, N₂ gas=100 sccm, Pressure=3.5 mTorr. Two mechanisms that may occur during plasma treatment are (1) surface cleaning by ion bombardment removal of the impurities contaminants, absorbants and native oxides on the COC surface and (2) formation of the thin layer 202a of nitrogenated carbon (C:N) at the surface of the COC layer 202. Referring to FIG. 4, the nitrogen plasma treatment significantly increases the surface energy and reactivity of the COC layer 202/202a to promote covalent bonding with the functional groups of the adhesion layer and, thus, significantly improves resist adhesion to the adhesion layer upon removal of the subsequently applied imprint template from contact with the resist.

As an alternate to N₂ plasma treatment as described above, N₂ gas flow may be introduced during the deposition of the COC layer to provide a nitrogenated COC layer. However, while the nitrogen content of the COC layer is uniform when this approach is utilized, resist adhesion is improved less with this approach than with N₂ plasma treatment, wherein a thin N₂-rich layer is formed at the surface of the COC layer.

Another alternate approach to introducing nitrogen into the COC layer is nitrogen ion implantation. However, it is difficult to control the nitrogen implantation depth in a thin COC layer of the type utilized in the manufacture of magnetic media. Additionally, if not properly controlled, the tail of the nitrogen implantation profile could extend through the COC layer and into the magnetic layer of the media, resulting in magnetic property degradation.

As shown in FIG. 3C, following formation of the nitrogenated carbon in a surface region 202a of the COC layer 202, an adhesion layer 204 is formed on the COC layer 202/202a. Those skilled in the art will appreciate that the adhesion layer 204 may comprise polymeric components with a carboxylic functional group capable of bonding to the COC layer 202/202a on the substrate 200 by forming covalent bonds, and with an additional functional group capable of bonding with a resist. For example, the adhesion layer 204 may comprise Valmat, which is commercially available from Molecular Imprints, Inc., applied in a Yield Engineering Systems YES-1224P vapor deposition oven. The typical materials utilized for the adhesion layer 204 comprise a multi-functional component having two ends and a linker group between the two ends. One end includes a tetravalent atom, such as a carboxylic functional group. The linker group is a hydrocarbon group with multiple carbon atoms. Covalent bonding is formed between the tetravalent atom of the first end and the COC layer 202/202a, while the second end of the multi-functional component binds to the resist 206. Further information regarding adhesion layer 204 may be obtained by reference to U.S. Patent Application Publication No. 2007/0212494, published on Sep. 13, 2007, and which is hereby incorporated by reference herein in its entirety.

Resist 206 is then formed on the upper surface of the adhesion layer 204 in the conventional manner, e.g. by spin coating or by drop dispensing, resulting in the structure shown in FIG. 3D. The resist material is selected to be soft relative to the material of the imprint template 208, the resist 206 typically comprising a thermoplastic material that can be heated to above its glass temperature, such that the material exhibits low viscosity and enhanced flow, or the resist can be a UV-curable monomer that is liquid at room temperature and cured by UV exposure (e.g., Monomat, which is commercially available from Molecular Imprints, Inc.).

As shown in FIG. 3E, the resist 206 is then contacted with an imprint template 208 having patterned features formed therein such that the resist 206 fills the patterned features of the imprint template 208 to form a negative image (or complementary image) of the imprint template 208 in the resist 206. The imprint template 208 is then separated from the resist 206 such that a negative image of the patterned features of the imprint template 208 is formed in the resist 206, as shown in FIG. 3F. Either mechanical force or electrostatic force may be utilized to press and separate the imprint template 208 and the resist 206. As is well known, suitable materials for the imprint template 208 include metals, dielectrics, semiconductors, ceramics and composite materials. The surface-molded resist 206 is then subjected to processing in accordance with conventional techniques, such as for example reactive ion etching (RIE) or wet chemical etching, to remove portions of the resist 206 to expose portions of the underlying substrate 200 for processing of the substrate 200, by for example e-beam lithography or RIE, to form, for example, a patterned magnetic medium.

The present invention will be used in some or all of the lithography processes used the fabrication of bit-patterned media (“BPM”). In particular, the present invention has use in the patterning of the magnetic media into the islands or bits that are associated with BPM. The characterization and specifications for BPM, as well as methods of manufacture, are known by the industry. See, e.g., Neil Robertson, “Magnetic Data Storage with Patterned Media,” presented May 2009 at the Nanomanufacturing Summitt 2009, and available at www.internano.org/ocs/index.php/NMS/NMS2009/paper. The manufacturing techniques for BPM are also reported in this publication, as well as in Rachid Sbiaa and Seidikkurippu N. Piramanayagam, “Patterned Media Towards Nano-Bit magnetic Recording: Fabrication and Challenges,” Recent Patents on Nanotechnology 2007, 1, 29-40. The relevant portions of these references are herein incorporated by reference, and if necessary, Applicants reserve the right to incorporate the text of some or all of these publications.

Since BPM has smaller and denser features than previously extant in other types of magnetic media, and since the commercial production throughput rates for BPM will be more demanding than those for other types of media fabrication, the present invention provides the ability for improved use of imprint lithography in BPM manufacture, while addressing overall BPM product and process market specifications.

For certain, current imprint lithography processes, we are presently unable to effectively remove the organic residues left behind by the lithography resists without sacrificing the nitrogenated COC layer. So, processing subsequent to the creation and/or use of the imprints using the methods of the claimed method, involves removal of the nitrogenated COC containing organic residues from the magnetic media with plasma etching of the carbon over coat and redeposition of a fresh layer of COC.

It should be understood that the particular embodiments of the invention described in this application have been provided as non-limiting examples and that other modifications and variations may occur to those skilled in the art without departing from the scope of the invention as expressed in the appended claims and their equivalents.

What is claimed is:

1. An imprint lithography method comprising:
introducing nitrogen into an upper surface region of a carbon overcoat (COC) layer;
forming an adhesion layer on the nitrogenated COC layer;
forming resist on the adhesion layer;
contacting the resist with an imprint template having patterned features formed therein such that the resist fills the patterned features of the imprint template; and
separating the imprint template from the resist such that a negative image of the patterned features of the imprint template is formed in the resist.

2. The imprint lithography method of claim 1, wherein the COC layer is formed on a substrate comprising a magnetic stack.

3. The imprint lithography method of claim 2, wherein the magnetic stack comprises a plurality of layers of cobalt-based materials.

4. The imprint lithography method of claim 3, wherein the cobalt-based materials are selected from the group consisting of cobalt-platinum alloy, cobalt-chromium alloy, cobalt-platinum-chromium alloy, cobalt-platinum oxide, cobalt-platinum-chromium oxide, cobalt-platinum-silicon and cobalt-platinum-chromium silicon.

5. The imprint lithography method of claim 2, wherein the magnetic stack includes additive elements selected from the group consisting of B, Ta, Mo, Cu, Nd, Nb, Sm, Ru, Re and combinations thereof.

6. The imprint lithography method of claim 1, wherein the COC layer comprises diamond-like carbon (DLC).

7. The imprint lithography method of claim 1, wherein the adhesion layer comprises polymeric components with a carboxylic functional group capable of bonding to the COC layer by forming covalent bonds.

8. The imprint lithography method of claim 7, wherein the adhesion layer comprises Valmat.

9. The imprint lithography method of claim 1, wherein the resist comprises a low viscosity photo-curable material comprising organic monomers.

10. The imprint lithography method of claim 9, wherein the resist comprises Monomat.

11. An imprint structure for use in imprint lithography, the imprint structure comprising:
a substrate;
a carbon overcoat (COC) layer formed on the substrate, the COC layer having a nitrogenated upper surface region formed therein;
an adhesion layer formed on the COC layer; and
resist formed on the adhesion layer.

12. The imprint structure of claim 11, wherein the substrate comprises a magnetic stack.

13. The imprint structure of claim 12, wherein the magnetic stack comprises a plurality of layers of cobalt-based materials.

14. The imprint structure of claim 13, wherein the cobalt-based materials are selected from the group consisting of cobalt-platinum alloy, cobalt-chromium alloy, cobalt-platinum-chromium alloy, cobalt-platinum oxide, cobalt-platinum-chromium oxide, cobalt-platinum-silicon and cobalt-platinum-chromium-silicon.

15. The imprint structure of claim 12, wherein the magnetic stack includes additive elements selected from the group consisting of B, Ta, Mo, Cu, Nd, Nb, Sm, Ru, Re and combinations thereof.

16. The imprint structure of claim 11, wherein the COC layer comprises diamond-like carbon (DLC).

17. The imprint structure of claim 1, wherein the adhesion layer comprises polymeric components with a carboxylic function group capable of bonding to the COC layer by forming covalent bonds.

18. The imprint structure of claim 17, wherein the adhesion layer comprises Valmat.

19. The imprint structure of claim 11, wherein the resist comprises a low viscosity photo-curable material comprising organic monomers.

20. The imprint structure of claim 19, wherein the resist comprises Monomat.
